(19) United States
(12) Patent Application Publication
(10) Pub. No.: US 2025/0137260 A1
(43) Pub. Date: May 1, 2025

(54) Modular Outdoor Shelter System

(71) Applicant: Sunjoy Industries Group Ltd., Galena, OH (US)

(72) Inventor: Sean Michael Banal, Galena, OH (US)

(21) Appl. No.: 18/934,010

(22) Filed: Oct. 31, 2024

Related U.S. Application Data
(60) Provisional application No. 63/546,567, filed on Oct. 31, 2023.

(51) Int. Cl. E04F 10/00; E04F 10/08; F21S 9/03; F21V 33/00; F21Y 115/10

(52) U.S. Cl. CPC E04F 10/005; E04F 10/08; F21S 9/032; F21V 33/006; F21Y 2115/10

(57) ABSTRACT

A modular outdoor shelter system is disclosed herein. The modular outdoor shelter system includes a first modular outdoor structure with a first plurality of corner support members disposed at respective corners of the first modular outdoor structure, a first plurality of roof beam members supported on the first plurality of corner support members, and a first roof structure supported on the first plurality of roof beam members; and a second modular outdoor structure with a second plurality of corner support members disposed at respective corners of the second modular outdoor structure, a second plurality of roof beam members supported on the second plurality of corner support members, and a second roof structure supported on the second plurality of roof beam members. The first modular outdoor structure is structurally configured to fit together with the second modular outdoor structure so as to form a single continuous outdoor structure.

### CROSS-REFERENCE TO RELATED APPLICATIONS

This patent application claims priority to, and incorporates by reference in its entirety, U.S. Provisional Patent Application No. 63/546,567, entitled “Modular Outdoor Shelter System”, filed on Oct. 31, 2023.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The invention generally relates to a modular outdoor shelter system. More particularly, the invention relates to a modular outdoor shelter system that includes a plurality of modular outdoor structures that are structurally configured to fit together with one another so as to form a single continuous outdoor structure.

### 2. Background and Description of Related Art

Portable outdoor shelters, such as portable gazebos, are useful for a myriad of different applications. For example, outdoor gazebos are often used for backyard patio gathering spaces. Because the outdoor gazebos are at least partially enclosed, table and chair sets may be arranged underneath the outdoor gazebos so that the individuals seated around the table may remain cooler by being shaded from direct sunlight. Also, when food is being served outside, a food serving table or tables are often placed underneath the gazebo to protect the food from direct sunlight and rain.

Although, conventional outdoor shelters are not designed to fit together with one another to form a larger overall structure, which may be needed by a user to accommodate certain activities that require a larger enclosed space than that which is available with a single conventional outdoor shelter.

Therefore, what is needed is a modular outdoor shelter system that includes a plurality of modular outdoor structures that are structurally configured to fit together with one another so as to form a single continuous outdoor structure.

### BRIEF SUMMARY OF EMBODIMENTS OF THE INVENTION

Accordingly, the present invention is directed to a modular outdoor shelter system that substantially obviates one or more problems resulting from the limitations and deficiencies of the related art.

In accordance with one or more embodiments of the present invention, there is provided a modular outdoor shelter system. The modular outdoor shelter system comprises a first modular outdoor structure, the first modular outdoor structure including a first plurality of corner support members disposed at respective corners of the first modular outdoor structure; a first plurality of roof beam members, the first plurality of roof beam members supported on the first plurality of corner support members; and a first roof structure, the first roof structure supported on the first plurality of roof beam members; and a second modular outdoor structure, the second modular outdoor structure including a second plurality of corner support members disposed at respective corners of the second modular outdoor structure; a second plurality of roof beam members, the second plurality of roof beam members supported on the second plurality of corner support members; and a second roof structure, the second roof structure supported on the second plurality of roof beam members. In these one or more embodiments, the first modular outdoor structure is structurally configured to fit together with the second modular outdoor structure so as to form a single continuous outdoor structure.

In a further embodiment of the present invention, the modular outdoor shelter system further comprises a third modular outdoor structure, the third modular outdoor structure including a third plurality of corner support members disposed at respective corners of the third modular outdoor structure; a third plurality of roof beam members, the third plurality of roof beam members supported on the third plurality of corner support members; and a third roof structure, the third roof structure supported on the third plurality of roof beam members. In this further embodiment, the third modular outdoor structure is structurally configured to fit together with the second modular outdoor structure so as to form a single continuous outdoor structure with the first and second modular outdoor structures.

In yet a further embodiment, the second roof structure of the second modular outdoor structure overhangs the first roof structure of the first modular outdoor structure so as to prevent or at least partially prevent sunlight and/or weather precipitation from entering a covered area formed by the single continuous outdoor structure.

In still a further embodiment, at least one of the first modular outdoor structure and the second modular outdoor structure comprises one or more roof brackets or clips for attaching the first modular outdoor structure to the second modular outdoor structure.

In yet a further embodiment, at least one of the first modular outdoor structure and the second modular outdoor structure comprises one or more corner support member brackets or clips for attaching the first modular outdoor structure to the second modular outdoor structure.

In still a further embodiment, at least one of the first modular outdoor structure and the second modular outdoor structure comprises one or more universal connector brackets for attaching the first modular outdoor structure to the second modular outdoor structure.

In yet a further embodiment, the one or more universal connector brackets are configured to slip on from over or under at least one of the first plurality of roof beam members and at least one of the second plurality of roof beam members to secure the first modular outdoor structure to the second modular outdoor structure.

In still a further embodiment, the one or more universal connector brackets are configured to be secured in place by a plurality of screws or magnets.

In yet a further embodiment, the one or more universal connector brackets are adjustable and/or expandable to accommodate different-sized roof beam members or corner support members.

In still a further embodiment, the one or more universal connector brackets comprise one or more slots for facilitating an adjustability and/or expandability thereof.

In yet a further embodiment, at least one of the first modular outdoor structure and the second modular outdoor structure comprises strip lighting extending vertically along a length of one or more of the first plurality of corner support members and/or along a length of one or more of the second plurality of corner support members.

In still a further embodiment, the strip lighting comprises a plurality of light-emitting diodes (LEDs).

In yet a further embodiment, the strip lighting further comprises one or more solar panels and one or more rechargeable battery packs for powering the strip lighting, the one or more solar panels configured to charge the one or more rechargeable battery packs and/or power the strip lighting when sunlight is available, and the one or more rechargeable battery packs configured to power the strip lighting when sunlight is not available.

In still a further embodiment, the strip lighting further comprises one or more electrical plugs for electrically coupling the strip lighting to a power source.

In yet a further embodiment, at least one of the first modular outdoor structure and the second modular outdoor structure is selected from a group consisting of: (i) a gazebo with a double-tiered hip roof, (ii) a louvered pergola, (iii) a pergola with a shade canopy, (iv) a gazebo with a gabled roof, (v) a gazebo with semi-translucent roof panels, (vi) an enclosed screen-house with a gabled roof, (vii) a pavilion with a single-angled skillion style roof, (viii) a pergola with a single-angled skillion style roof, (ix) a gazebo with a single-angled skillion style roof, (x) a gazebo with a single-tiered pyramid hip roof, and (xi) an enclosed screen-house with a single-tiered pyramid hip roof.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is one perspective view of a modular outdoor shelter system, according to a first illustrative embodiment of the invention, wherein modular outdoor structures of the system are depicted prior to being assembled together to form a single continuous outdoor structure;

FIG. 2 is another perspective view of the modular outdoor shelter system of FIG. 1, wherein the modular outdoor structures of the system have been assembled together to form a single continuous outdoor structure;

FIG. 3 is a perspective view of a modular outdoor shelter system, according to a second illustrative embodiment of the invention, wherein the modular outdoor structures of the system have been assembled together to form a single continuous outdoor structure;

FIG. 4 is a perspective view of a modular outdoor shelter system, according to a third illustrative embodiment of the invention, wherein the modular outdoor structures of the system have been assembled together to form a single continuous outdoor structure;

FIG. 5 is a perspective view of a modular outdoor shelter system, according to a fourth illustrative embodiment of the invention, wherein a universal connector bracket for securing the modular outdoor structures together is additionally depicted;

FIG. 6 is a perspective view of a modular outdoor shelter system, according to a fifth illustrative embodiment of the invention, wherein the modular outdoor structures of the system have been assembled together to form a single continuous outdoor structure;

FIG. 7 is a perspective view of a modular outdoor shelter system, according to a sixth illustrative embodiment of the invention, wherein the modular outdoor structures of the system have been assembled together to form a single continuous outdoor structure;

FIG. 8 is a perspective view of a modular outdoor shelter system, according to a seventh illustrative embodiment of the invention, wherein the modular outdoor structures of the system have been assembled together to form a single continuous outdoor structure;

FIG. 9 is a perspective view of a modular outdoor shelter system, according to an eighth illustrative embodiment of the invention, wherein the modular outdoor structures of the system have been assembled together to form a single continuous outdoor structure;

FIG. 10 is one perspective view of a modular outdoor shelter system, according to a ninth illustrative embodiment of the invention, wherein modular outdoor structures of the system are depicted prior to being assembled together to form a single continuous outdoor structure; and

FIG. 11 is another perspective view of the modular outdoor shelter system of FIG. 10, wherein the modular outdoor structures of the system have been assembled together to form a single continuous outdoor structure.

Throughout the figures, where applicable, the same parts are always denoted using the same reference characters so that, as a general rule, they will only be described once.

### DETAILED DESCRIPTION OF EMBODIMENTS OF THE INVENTION

In one or more embodiments, a modular outdoor shelter system includes a first modular outdoor structure, a second modular outdoor structure, and a third modular outdoor structure. In these one or more embodiments, the first modular outdoor structure includes a first plurality of corner support members disposed at respective corners of the first modular outdoor structure; a first plurality of roof beam members, the first plurality of roof beam members supported on the first plurality of corner support members; and a first roof structure, the first roof structure supported on the first plurality of roof beam members. Similarly, in these one or more embodiments, the second modular outdoor structure includes a second plurality of corner support members disposed at respective corners of the second modular outdoor structure; a second plurality of roof beam members, the second plurality of roof beam members supported on the second plurality of corner support members; and a second roof structure, the second roof structure supported on the second plurality of roof beam members. Also, in these one or more embodiments, the third modular outdoor structure includes a third plurality of corner support members disposed at respective corners of the third modular outdoor structure; a third plurality of roof beam members, the third plurality of roof beam members supported on the third plurality of corner support members; and a third roof structure, the third roof structure supported on the third plurality of roof beam members. In these one or more embodiments, the first modular outdoor structure and the third modular outdoor structure are structurally configured to fit together with the second modular outdoor structure so as to form a single continuous outdoor structure.

In one or more embodiments, the second roof structure of the second modular outdoor structure overhangs the first roof structure of the first modular outdoor structure and the third roof structure of the third modular outdoor structure so as to prevent sunlight and/or weather precipitation from entering a covered area formed by the single continuous outdoor structure.

In one or more embodiments, the first modular outdoor structure and the third modular outdoor structure comprise a plurality of roof brackets or clips for attaching the first modular outdoor structure and the third modular outdoor structure to the second modular outdoor structure. In these one or more embodiments, the roof brackets or clips may be in a form of the universal connector brackets 470 described hereinafter.

In one or more embodiments, the first modular outdoor structure and the third modular outdoor structure comprise a plurality of corner support member brackets or clips for attaching the first modular outdoor structure and the third modular outdoor structure to the second modular outdoor structure.

In one or more embodiments, at least one of the first modular outdoor structure, the second modular outdoor structure, and the third modular outdoor structure is selected from a group consisting of: (i) a gazebo with a double-tiered hip roof, (ii) a louvered pergola, (iii) a pergola with a shade canopy, (iv) a gazebo with a gabled roof, (v) a gazebo with semi-translucent roof panels, (vi) an enclosed screen-house with a gabled roof, (vii) a pavilion with a single-angled skillion style roof, (viii) a pergola with a single-angled skillion style roof, (ix) a gazebo with a single-angled skillion style roof, (x) a gazebo with a single-tiered pyramid hip roof, and (xi) an enclosed screen-house with a single-tiered pyramid hip roof.

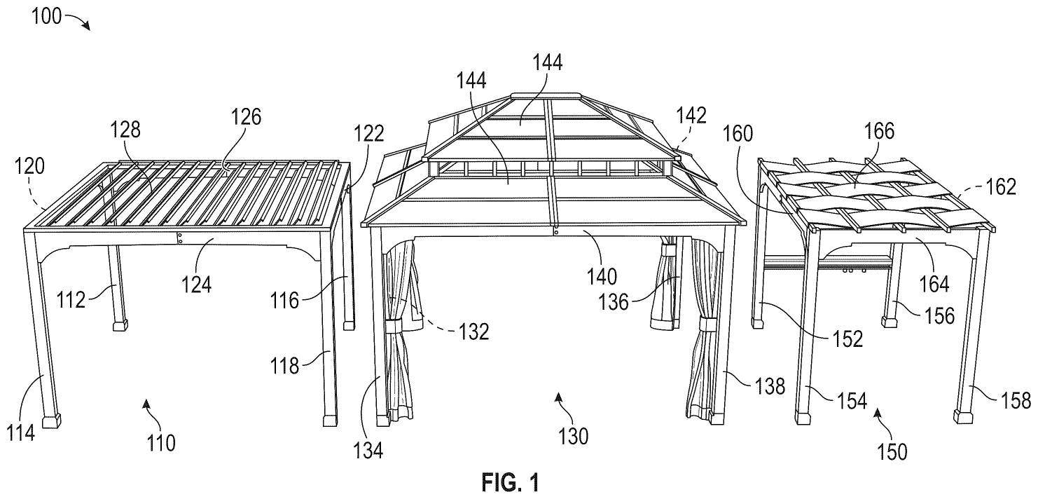

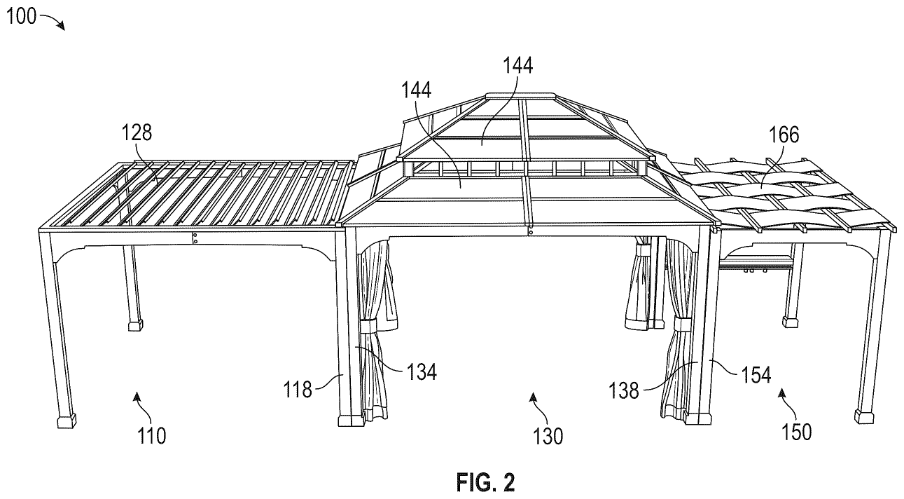

A first illustrative embodiment of a modular outdoor shelter system 100 is depicted in FIGS. 1 and 2. In the first illustrative embodiment, the modular outdoor structures include: (i) a gazebo with double-tiered hip roof (center structure 130 in FIGS. 1 and 2), (ii) a louvered pergola (left side structure 110 in FIGS. 1 and 2), and (iii) a small space pergola with fabric shade canopy (right side structure 150 in FIGS. 1 and 2). The roof 144 of the centrally located gazebo 130 features a unique overhang to prevent or at least partially prevent sunlight and/or weather precipitation from entering a covered area formed by the single continuous outdoor structure 100.

As shown in FIGS. 1 and 2, the first illustrative embodiment comprises a “family” of different structures 110, 130, 150, unified in their proportions, visual style and silhouette, to create multiple combinations, suiting different needs and spaces. Each structure is uniquely attractive on its own, or further paired with other structures in the collection. As described hereinafter, one or more brackets or braces may lock the structures together in their desired positions.

In the first illustrative embodiment, referring to FIGS. 1 and 2, the modular outdoor shelter system 100 includes a first modular outdoor structure 110, a second modular outdoor structure 130, and a third modular outdoor structure 150. Referring to FIG. 1 of this illustrative embodiment, the first modular outdoor structure 110 includes a first plurality of corner support members 112, 114, 116, 118 disposed at respective corners of the first modular outdoor structure 110; a first plurality of roof beam members 120, 122, 124, 126, the first plurality of roof beam members 120, 122, 124, 126 supported on the first plurality of corner support members 112, 114, 116, 118; and a first roof structure 128, the first roof structure 128 supported on the first plurality of roof beam members 120, 122, 124, 126. Similarly, in this illustrative embodiment, with reference again to FIG. 1, the second modular outdoor structure 130 includes a second plurality of corner support members 132, 134, 136, 138 disposed at respective corners of the second modular outdoor structure 130; a second plurality of roof beam members 140, 142, the second plurality of roof beam members 140, 142 supported on the second plurality of corner support members 132, 134, 136, 138; and a second roof structure 144, the second roof structure 144 supported on the second plurality of roof beam members 140, 142. While not visible in FIGS. 1 and 2, in the first illustrative embodiment, the second modular outdoor structure 130 also includes first and second end roof beam members next to respective first and third modular outdoor structures 110, 150 such that the second modular outdoor structure 130 has a total of four (4) roof beam members overall (i.e., side roof beam members 140, 142 and first and second end roof beam members). Also, in this illustrative embodiment, referring again to FIG. 1, the third modular outdoor structure 150 includes a third plurality of corner support members 152, 154, 156, 158 disposed at respective corners of the third modular outdoor structure 150; a third plurality of roof beam members 160, 162, 164, the third plurality of roof beam members 160, 162, 164 supported on the third plurality of corner support members 152, 154, 156, 158; and a third roof structure 166, the third roof structure 166 supported on the third plurality of roof beam members 160, 162, 164. While not visible in FIGS. 1 and 2, in the first illustrative embodiment, the third modular outdoor structure 150 also includes a rear side roof beam member such that the third modular outdoor structure 150 has a total of four (4) roof beam members overall (i.e., roof beam members 160, 162, 164 and the rear side roof beam member). In the first illustrative embodiment, as shown in FIG. 2, the first modular outdoor structure 110 and the third modular outdoor structure 150 are structurally configured to fit together with the second modular outdoor structure 130 so as to form a single continuous outdoor structure 100.

In the first illustrative embodiment, as shown in FIG. 2, the second roof structure 144 of the second modular outdoor structure 130 overhangs the first roof structure 128 of the first modular outdoor structure 110 and the third roof structure 166 of the third modular outdoor structure 150 so as to prevent or at least partially prevent sunlight and/or weather precipitation from entering a covered area formed by the single continuous outdoor structure 100.

As shown in FIG. 2, in the illustrative embodiment, when the modular outdoor structures 110, 130, 150 of the system have been assembled together to form a single continuous outdoor structure 100, corner support members 118, 134 and 138, 154 of adjacent modular outdoor structures 110, 130 and 130, 150 are abutted up against one another and aligned with one another. Also, in the illustrative embodiment, when the modular outdoor structures 110, 130, 150 of the system have been assembled together to form a single continuous outdoor structure 100, the roof structure 144 of the second modular outdoor structure 130 overhangs the roof structure 128 of the first modular outdoor structure 110 on a first end thereof, and the roof structure 144 of the second modular outdoor structure 130 overhangs the roof structure 166 of the third modular outdoor structure 150 on a second end thereof.

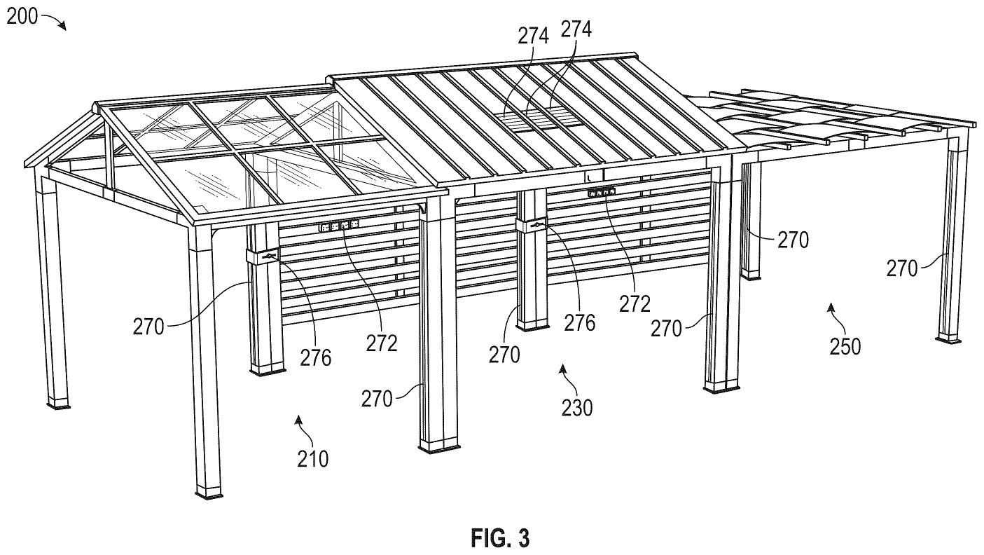

A second illustrative embodiment of a modular outdoor shelter system 200 is depicted in FIG. 3. In the second illustrative embodiment, the modular outdoor structures include: (i) a gazebo with a gabled roof (center structure 230 in FIG. 3), (ii) a small space gazebo with a gabled roof and semi-translucent polycarbonate (PC) panels (left side structure 210 in FIG. 3), and (iii) a pergola with a fabric shade canopy (right side structure 250 in FIG. 3). The roof of the centrally located gazebo 230 features a unique overhang to prevent or at least partially prevent sunlight and/or weather precipitation from entering a covered area formed by the single continuous outdoor structure 200.

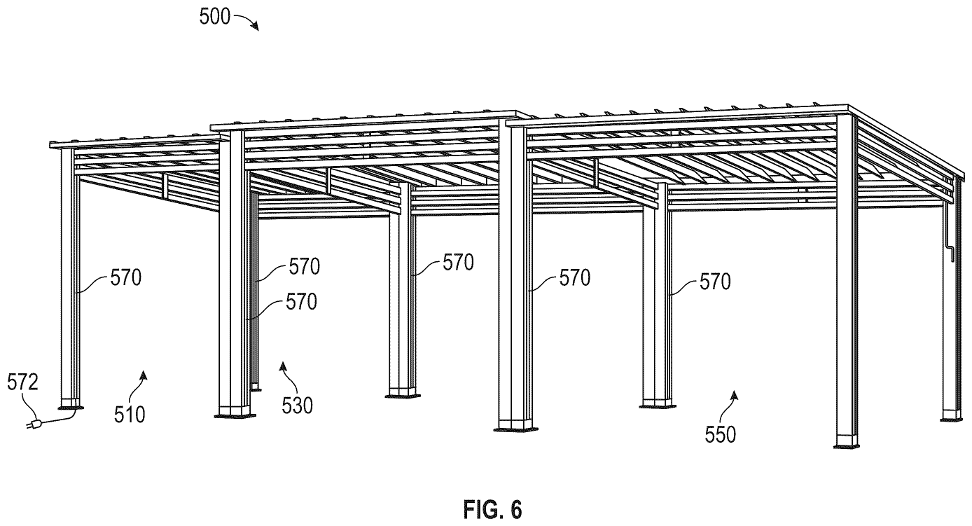

As shown in FIG. 3, the second illustrative embodiment may include vertical light-emitting diode (LED) strip lighting 270 integrated down the posts of the structures 210, 230, 250. In the illustrative embodiment, as shown in FIG. 3, the strip lighting 270 may further comprise one or more solar panels 274 and one or more rechargeable battery packs 272 electrically coupled to one another and the strip lighting 270 for powering the strip lighting 270, the one or more solar panels 274 configured to charge the one or more rechargeable battery packs 272 and/or power the strip lighting 270 when sunlight is available, and the one or more rechargeable battery packs 272 configured to power the strip lighting 270 when sunlight is not available. Alternatively, or in addition to the one or more solar panels 274 and one or more rechargeable battery packs 272, the strip lighting 270 may further comprise one or more electrical plugs 572 (see FIG. 6) for electrically coupling the strip lighting 270 to a power source in the illustrative embodiment.

Also, as shown in FIG. 3, the second illustrative embodiment may include a plurality of corner support member brackets 276 to lock adjacent structures together. Each corner support member bracket 276 may slip on over the corner support members of the structures 210, 230, 250, as shown in FIG. 3. The corner support member brackets 276 may be similar in construction to the universal connector brackets 470 that will be described in detail hereinafter. Advantageously, in the illustrative embodiment, all of the corner support member brackets 276 are secured from the interior of the modular outdoor structures so that no bolts or screws are visible on the exterior.

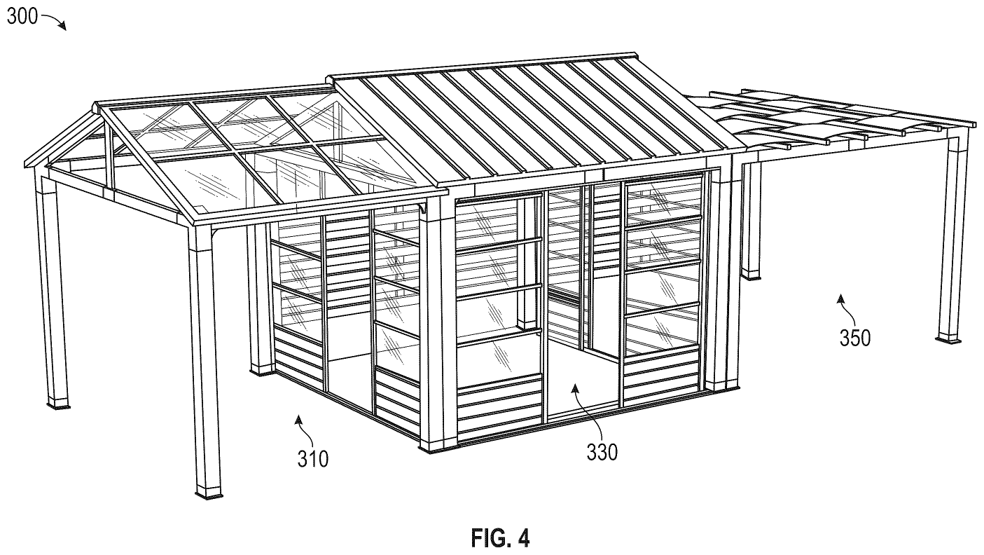

A third illustrative embodiment of a modular outdoor shelter system 300 is depicted in FIG. 4. In the third illustrative embodiment, the modular outdoor structures include: (i) an enclosed screen-house with a gabled roof (center structure 330 in FIG. 4), (ii) a small space gazebo with a gabled roof and semi-translucent polycarbonate (PC) panels (left side structure 310 in FIG. 4), and (iii) a pergola with a fabric shade canopy (right side structure 350 in FIG. 4). The roof of the centrally located screen-house 330 features a unique overhang to prevent or at least partially prevent sunlight and/or weather precipitation from entering a covered area formed by the single continuous outdoor structure 300.

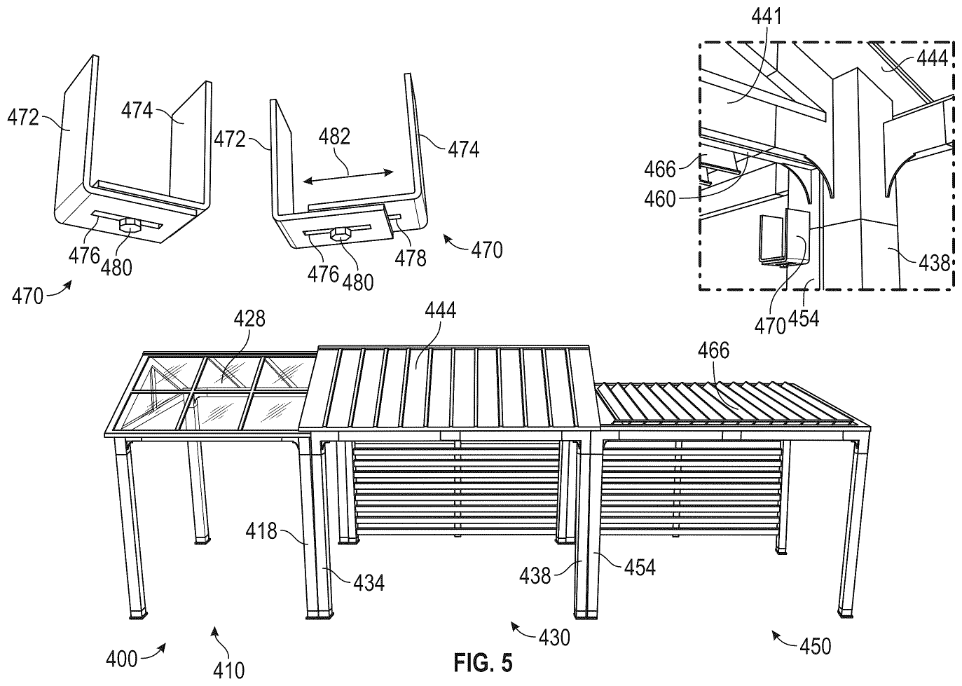

A fourth illustrative embodiment of a modular outdoor shelter system 400 is depicted in FIG. 5. In the fourth illustrative embodiment, the modular outdoor structures include: (i) a gazebo with a gabled roof (center structure 430 in FIG. 5), (ii) a small space gazebo with a gabled roof and semi-translucent polycarbonate (PC) panels (left side structure 410 in FIG. 5), and (iii) a louvered pergola (right side structure 450 in FIG. 5). The roof 444 of the centrally located gazebo 430 features a unique overhang to prevent or at least partially prevent sunlight and/or weather precipitation from entering a covered area formed by the single continuous outdoor structure 400.

As shown in the top portion of FIG. 5, the fourth illustrative embodiment may include a plurality of universal connector brackets 470 to lock adjacent structures together. Each universal connector bracket 470 may slip on from under (or over) the cross-beams of the structures, as necessary. Also, each universal connector bracket 470 may be fixed in place by set-screws or magnets. Each universal connector bracket 470 may have an adjustable/expandable slotted design to accommodate different size cross-beams/corner hardware. Advantageously, in the illustrative embodiment, all of the connector brackets 470 are secured from the interior of the modular outdoor structures so that no bolts or screws are visible on the exterior.

In the illustrative embodiment, referring to the top left portion of FIG. 5, it can be seen that each universal connector bracket 470 may include a first L-shaped member 472 that is slidably coupled to a second L-shaped member 474 by a fastener member 480 (e.g., a bolt or screw). To adjust the opening width of each universal connector bracket 470, a user simply loosens the fastener member 480, slides the first and second L-shaped members 474 relative to one another to adjust the opening width (e.g., to accommodate different roof beam widths, as diagrammatically represented by the arrow 482 in FIG. 5), and then fixes the positions of the first and second L-shaped members 474 relative to one another by tightening the fastener member 480. As shown in the top left portion of FIG. 5, in the illustrative embodiment, the first and second L-shaped members 472, 474 include first and second slots 476, 478, respectfully, for accommodating the slidable adjustability of the universal connector bracket 470. The fastener member 480 extends through the first and second slots 476, 478 and may be secured by a nut on the interior side.

In the illustrative embodiment, referring to the top right portion of FIG. 5, it can be seen that the universal connector bracket 470 may be configured to be fitted over adjacent roof beam members 441, 460 from underneath the roof beam members 441, 460, and then secured in place by tightening the fastener member 480. The other universal connector brackets 470 may be secured in a similar manner to adjacent roof beam members of the modular structures 410, 430, 450 to form the single continuous outdoor structure 400. As shown in the bottom portion of FIG. 5, in the illustrative embodiment, when the modular outdoor structures 410, 430, 450 of the system have been assembled together to form a single continuous outdoor structure 400, corner support members 418, 434 and 438, 454 of adjacent modular outdoor structures 410, 430 and 430, 450 are abutted up against one another and aligned with one another. Also, in the illustrative embodiment, when the modular outdoor structures 410, 430, 450 of the system have been assembled together to form a single continuous outdoor structure 400, the roof structure 444 of the second modular outdoor structure 430 overhangs the roof structure 428 of the first modular outdoor structure 410 on a first end thereof, and the roof structure 444 of the second modular outdoor structure 430 overhangs the roof structure 466 of the third modular outdoor structure 450 on a second end thereof.

A fifth illustrative embodiment of a modular outdoor shelter system 500 is depicted in FIG. 6. In the fifth illustrative embodiment, the modular outdoor structures include: (i) a pavilion with a single-angled skillion (lean-to) style roof (center structure 530 in FIG. 6), (ii) a small space gazebo a single-angled skillion (lean-to) style roof (left side structure 510 in FIG. 6), and (iii) a louvered pergola with a single-angled skillion (lean-to) style roof (right side structure 550 in FIG. 6). The roof of the centrally located pavilion 530 features a unique overhang to prevent or at least partially prevent sunlight and/or weather precipitation from entering a covered area formed by the single continuous outdoor structure 500.

As shown in FIG. 6, the fifth illustrative embodiment may include vertical light-emitting diode (LED) strip lighting 570 integrated down the posts of the structures 510, 530, 550. In the fifth illustrative embodiment, as described above for the second illustrative embodiment of FIG. 3, the strip lighting 570 may further comprise one or more solar panels and one or more rechargeable battery packs for powering the strip lighting 570, the one or more solar panels configured to charge the one or more rechargeable battery packs and/or power the strip lighting 570 when sunlight is available, and the one or more rechargeable battery packs configured to power the strip lighting 570 when sunlight is not available. Alternatively, or in addition to the one or more solar panels and one or more rechargeable battery packs, the strip lighting 570 may further comprise one or more electrical plugs 572 (see FIG. 6) for electrically coupling the strip lighting 570 to a power source in the illustrative embodiment.

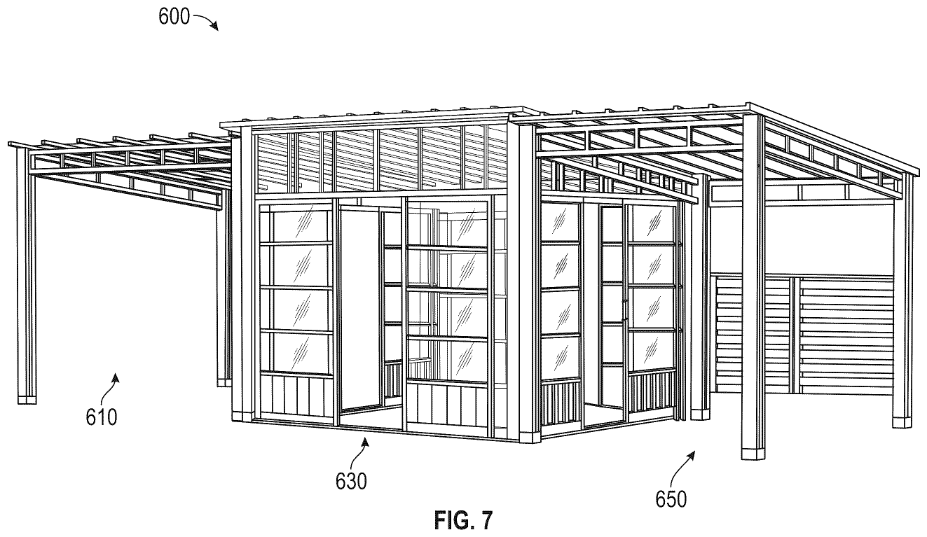

A sixth illustrative embodiment of a modular outdoor shelter system 600 is depicted in FIG. 7. In the sixth illustrative embodiment, the modular outdoor structures include: (i) an enclosed screen-house with a single-angled skillion (lean-to) style roof (center structure 630 in FIG. 7), (ii) a pergola with a single-angled skillion (lean-to) style roof and fabric shade canopy (left side structure 610 in FIG. 7), and (iii) a small space gazebo with a single-angled skillion (lean-to) style roof (right side structure 650 in FIG. 7). The roof of the centrally located screen-house 630 features a unique overhang to prevent or at least partially prevent sunlight and/or weather precipitation from entering a covered area formed by the single continuous outdoor structure 600.

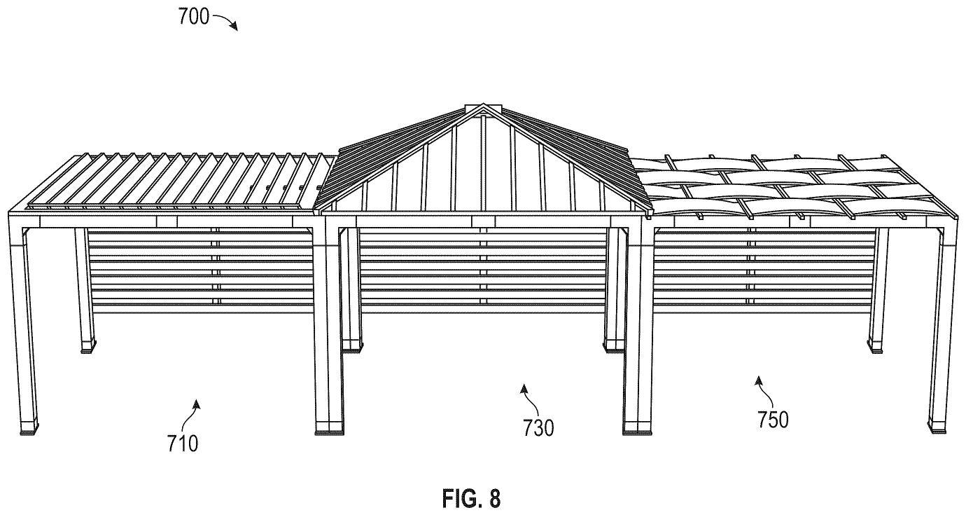

A seventh illustrative embodiment of a modular outdoor shelter system 700 is depicted in FIG. 8. In the seventh illustrative embodiment, the modular outdoor structures include: (i) a gazebo with a single-tiered pyramid hip roof (center structure 730 in FIG. 8), (ii) a louvered pergola (left side structure 710 in FIG. 8), and (iii) a pergola with a fabric shade canopy (right side structure 750 in FIG. 8). The roof of the centrally located gazebo 730 features a unique overhang to prevent or at least partially prevent sunlight and/or weather precipitation from entering a covered area formed by the single continuous outdoor structure 700.

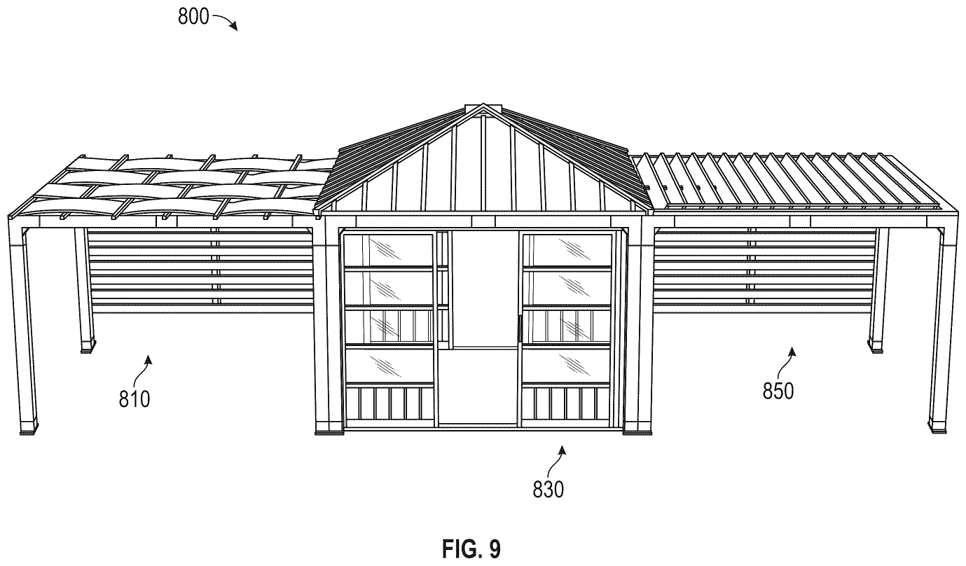

An eighth illustrative embodiment of a modular outdoor shelter system 800 is depicted in FIG. 9. In the eighth illustrative embodiment, the modular outdoor structures include: (i) an enclosed screen-house with a single-tiered pyramid hip roof (center structure 830 in FIG. 9), (ii) a pergola with a fabric shade canopy (left side structure 810 in FIG. 9), and (iii) a louvered pergola (right side structure 850 in FIG. 9). The roof of the centrally located screen-house 830 features a unique overhang to prevent or at least partially prevent sunlight and/or weather precipitation from entering a covered area formed by the single continuous outdoor structure 800.

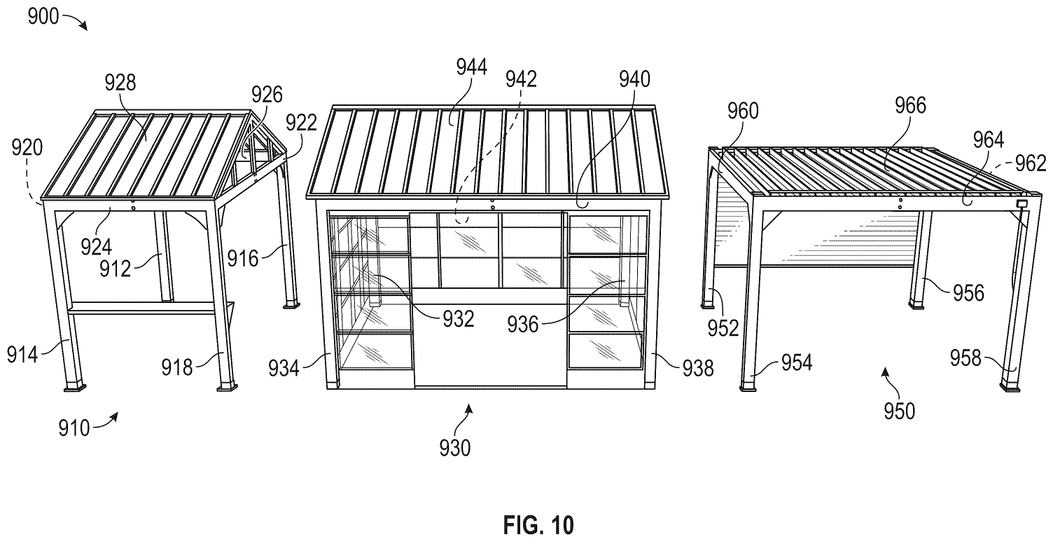

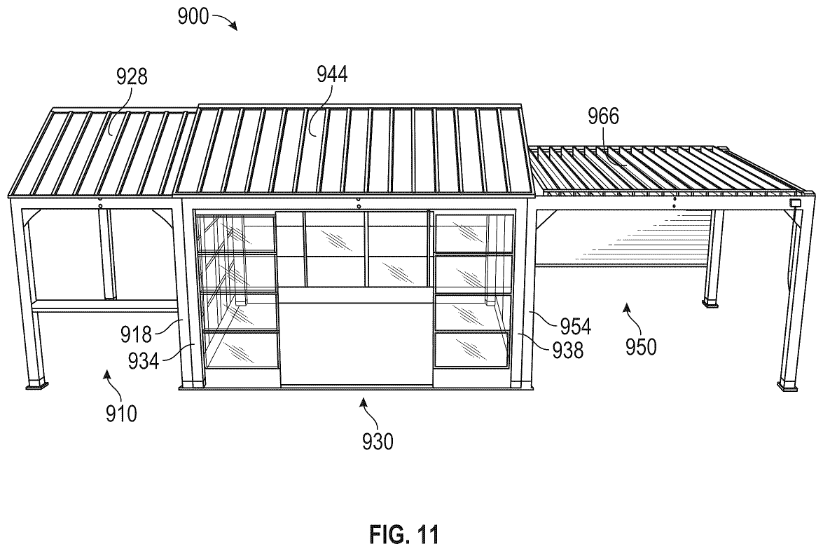

A ninth illustrative embodiment of a modular outdoor shelter system 900 is depicted in FIGS. 10 and 11. In the ninth illustrative embodiment, the modular outdoor structures include: (i) an enclosed screen-house with a gabled roof (center structure 930 in FIGS. 10 and 11), (ii) a small space gazebo with a gabled roof (left side structure 910 in FIGS. 10 and 11), and (iii) a louvered pergola (right side structure 950 in FIGS. 10 and 11). The roof 944 of the centrally located screen-house 930 features a unique overhang to prevent or at least partially prevent sunlight and/or weather precipitation from entering a covered area formed by the single continuous outdoor structure 900.

As shown in FIGS. 10 and 11, the ninth illustrative embodiment comprises a “family” of different structures 910, 930, 950, unified in their proportions, visual style and silhouette, to create multiple combinations, suiting different needs and spaces. Each structure is uniquely attractive on its own, or further paired with other structures in the collection. As described above in the preceding embodiments, one or more brackets or braces may lock the structures together in their desired positions.

In the ninth illustrative embodiment, referring to FIGS. 10 and 11, the modular outdoor shelter system 900 includes a first modular outdoor structure 910, a second modular outdoor structure 930, and a third modular outdoor structure 950. Referring to FIG. 10 of this illustrative embodiment, the first modular outdoor structure 910 includes a first plurality of corner support members 912, 914, 916, 918 disposed at respective corners of the first modular outdoor structure 910; a first plurality of roof beam members 920, 922, 924, 926, the first plurality of roof beam members 920, 922, 924, 926 supported on the first plurality of corner support members 912, 914, 916, 918; and a first roof structure 928, the first roof structure 928 supported on the first plurality of roof beam members 920, 922, 924, 926. Similarly, in this illustrative embodiment, with reference again to FIG. 10, the second modular outdoor structure 930 includes a second plurality of corner support members 932, 934, 936, 938 disposed at respective corners of the second modular outdoor structure 930; a second plurality of roof beam members 940, 942, the second plurality of roof beam members 940, 942 supported on the second plurality of corner support members 932, 934, 936, 938; and a second roof structure 944, the second roof structure 944 supported on the second plurality of roof beam members 940, 942. While not visible in FIGS. 10 and 11, in the ninth illustrative embodiment, the second modular outdoor structure 930 also includes first and second end roof beam members next to respective first and third modular outdoor structures 910, 950 such that the second modular outdoor structure 930 has a total of four (4) roof beam members overall (i.e., side roof beam members 940, 942 and first and second end roof beam members). Also, in this illustrative embodiment, referring again to FIG. 10, the third modular outdoor structure 950 includes a third plurality of corner support members 952, 954, 956, 958 disposed at respective corners of the third modular outdoor structure 950; a third plurality of roof beam members 960, 962, 964, the third plurality of roof beam members 960, 962, 964 supported on the third plurality of corner support members 952, 954, 956, 958; and a third roof structure 966, the third roof structure 966 supported on the third plurality of roof beam members 960, 962, 964. While not visible in FIGS. 10 and 11, in the ninth illustrative embodiment, the third modular outdoor structure 950 also includes a rear side roof beam member such that the third modular outdoor structure 950 has a total of four (4) roof beam members overall (i.e., roof beam members 960, 962, 964 and the rear side roof beam member). In the ninth illustrative embodiment, as shown in FIG. 11, the first modular outdoor structure 910 and the third modular outdoor structure 950 are structurally configured to fit together with the second modular outdoor structure 930 so as to form a single continuous outdoor structure 900.

In the ninth illustrative embodiment, as shown in FIG. 11, the second roof structure 944 of the second modular outdoor structure 930 overhangs the first roof structure 928 of the first modular outdoor structure 910 and the third roof structure 966 of the third modular outdoor structure 950 so as to prevent or at least partially prevent sunlight and/or weather precipitation from entering a covered area formed by the single continuous outdoor structure 900.

As shown in FIG. 11, in the illustrative embodiment, when the modular outdoor structures 910, 930, 950 of the system have been assembled together to form a single continuous outdoor structure 900, corner support members 918, 934 and 938, 954 of adjacent modular outdoor structures 910, 930 and 930, 950 are abutted up against one another and aligned with one another. Also, in the illustrative embodiment, when the modular outdoor structures 910, 930, 950 of the system have been assembled together to form a single continuous outdoor structure 900, the roof structure 944 of the second modular outdoor structure 930 overhangs the roof structure 928 of the first modular outdoor structure 910 on a first end thereof, and the roof structure 944 of the second modular outdoor structure 930 overhangs the roof structure 966 of the third modular outdoor structure 950 on a second end thereof.

It is readily apparent that the aforedescribed modular outdoor shelter systems offer numerous advantages. Advantageously, the plurality of modular outdoor structures forming the modular outdoor shelter systems are structurally configured to fit together with one another so as to form a single continuous outdoor structure for suiting different space needs of a user.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A modular outdoor shelter system, comprising:
a first modular outdoor structure, the first modular outdoor structure including:
a first plurality of corner support members disposed at respective corners of the first modular outdoor structure;
a first plurality of roof beam members, the first plurality of roof beam members supported on the first plurality of corner support members; and
a first roof structure, the first roof structure supported on the first plurality of roof beam members; and
a second modular outdoor structure, the second modular outdoor structure including:
a second plurality of corner support members disposed at respective corners of the second modular outdoor structure;
a second plurality of roof beam members, the second plurality of roof beam members supported on the second plurality of corner support members; and
a second roof structure, the second roof structure supported on the second plurality of roof beam members;
wherein the first modular outdoor structure is structurally configured to fit together with the second modular outdoor structure so as to form a single continuous outdoor structure.

2. The modular outdoor shelter system according to claim 1, further comprising:
a third modular outdoor structure, the third modular outdoor structure including:
a third plurality of corner support members disposed at respective corners of the third modular outdoor structure;
a third plurality of roof beam members, the third plurality of roof beam members supported on the third plurality of corner support members; and
a third roof structure, the third roof structure supported on the third plurality of roof beam members;
wherein the third modular outdoor structure is structurally configured to fit together with the second modular outdoor structure so as to form a single continuous outdoor structure with the first and second modular outdoor structures.

3. The modular outdoor shelter system according to claim 1, wherein the second roof structure of the second modular outdoor structure overhangs the first roof structure of the first modular outdoor structure so as to prevent or at least partially prevent sunlight and/or weather precipitation from entering a covered area formed by the single continuous outdoor structure.

4. The modular outdoor shelter system according to claim 1, wherein at least one of the first modular outdoor structure and the second modular outdoor structure comprises one or more roof brackets or clips for attaching the first modular outdoor structure to the second modular outdoor structure.

5. The modular outdoor shelter system according to claim 1, wherein at least one of the first modular outdoor structure and the second modular outdoor structure comprises one or more corner support member brackets or clips for attaching the first modular outdoor structure to the second modular outdoor structure.

6. The modular outdoor shelter system according to claim 1, wherein at least one of the first modular outdoor structure and the second modular outdoor structure comprises one or more universal connector brackets for attaching the first modular outdoor structure to the second modular outdoor structure.

7. The modular outdoor shelter system according to claim 6, wherein the one or more universal connector brackets are configured to slip on from over or under at least one of the first plurality of roof beam members and at least one of the second plurality of roof beam members to secure the first modular outdoor structure to the second modular outdoor structure.

8. The modular outdoor shelter system according to claim 6, wherein the one or more universal connector brackets are configured to be secured in place by a plurality of screws or magnets.

9. The modular outdoor shelter system according to claim 6, wherein the one or more universal connector brackets are adjustable and/or expandable to accommodate different-sized roof beam members or corner support members.

10. The modular outdoor shelter system according to claim 9, wherein the one or more universal connector brackets comprise one or more slots for facilitating an adjustability and/or expandability thereof.

11. The modular outdoor shelter system according to claim 1, wherein at least one of the first modular outdoor structure and the second modular outdoor structure comprises strip lighting extending vertically along a length of one or more of the first plurality of corner support members and/or along a length of one or more of the second plurality of corner support members.

12. The modular outdoor shelter system according to claim 11, wherein the strip lighting comprises a plurality of light-emitting diodes (LEDs).

13. The modular outdoor shelter system according to claim 11, wherein the strip lighting further comprises one or more solar panels and one or more rechargeable battery packs for powering the strip lighting, the one or more solar panels configured to charge the one or more rechargeable battery packs and/or power the strip lighting when sunlight is available, and the one or more rechargeable battery packs configured to power the strip lighting when sunlight is not available.

14. The modular outdoor shelter system according to claim 11, wherein the strip lighting further comprises one or more electrical plugs for electrically coupling the strip lighting to a power source.

15. The modular outdoor shelter system according to claim 1, wherein at least one of the first modular outdoor structure and the second modular outdoor structure is selected from a group consisting of: (i) a gazebo with double-tiered hip roof, (ii) a louvered pergola, (iii) a pergola with a shade canopy, (iv) a gazebo with a gabled roof, (v) a gazebo with semi-translucent roof panels, (vi) an enclosed screen-house with a gabled roof, (vii) a pavilion with a single-angled skillion style roof, (viii) a pergola with a single-angled skillion style roof, (ix) a gazebo with a single-angled skillion style roof, (x) a gazebo with a single-tiered pyramid hip roof, and (xi) an enclosed screen-house with a single-tiered pyramid hip roof.
